(19) United States
(12) Patent Application Publication
(10) Pub. No.: US 2025/0123404 A1
(43) Pub. Date: Apr. 17, 2025

(54) METHOD FOR REDUCING THE EFFECTS OF NOISE SUPPRESSION ON THE MEASUREMENT OF THE CARRIER PHASE OF A SATELLITE NAVIGATION SIGNAL AT THE POINT OF ITS RECEPTION AND APPLICATIONS OF THIS METHOD

(71) Applicant: DEUTSCHES ZENTRUM FÜR LUFT- UND RAUMFAHRT e.V., Bonn (DE)

(72) Inventors: Tobias BAMBERG, Overath (DE); Michael MEURER, Weßling (DE)

(21) Appl. No.: 18/728,649

(22) PCT Filed: Jan. 24, 2023
(86) PCT No.: PCT/EP2023/051647

§ 371 Date: Jul. 12, 2024

(30) Foreign Application Priority Data
Jan. 24, 2022 (DE) 10 2022 101 576.9

(51) Int. Cl. G01S 19/21; G01S 19/23; H04B 7/0426

(52) U.S. Cl. CPC G01S 19/21; G01S 19/23; H04B 7/043

(57) ABSTRACT

The invention relates to a method for reducing the effects of noise suppression on the measurement of the phases of satellite navigation signals at the point of their reception, wherein, in the method, a one-dimensional or multi-dimensional antenna array is provided with multiple reception antennas, satellite navigation signals received by the reception antennas are processed in a signal processing unit, the received satellite navigation signals undergo noise suppression in the signal processing unit by means of a spatial filter, i.e., by means of spatial filtering, for example by a power inversion (PI) filter or a projection filter, and after the noise suppression by means of the signal processing unit, the carrier phase of at least one or each satellite navigation signal is determined and is corrected by calculating parameters of one or more eigenbeamformers.

The present application claims the priority of the German Patent Application 10 2022 101 576.9 of Jan. 24, 2022, the content of which is hereby incorporated by reference into the subject matter of the present patent application.

The invention relates to a method for reducing the effects of noise suppression on the measurement of the carrier phase of a satellite navigation signal at the point of its reception. The invention also relates to a method for determining the pseudo-distance of a receiver for satellite navigation signals to a satellite and a method for determining the position of a receiver for satellite navigation signals, in both of which methods the method is used to reduce the effects of interference suppression on the measurement of the carrier phase of the satellite navigation signal.

Global Navigation Satellite Systems (GNSS) receivers are susceptible to interference signals. One successful method for mitigating interference signals is the use of multi-antenna systems, which superimpose the input signals of the individual antenna channels in a suitable manner, thus enabling interference signal suppression. For this purpose, the signals are multiplied by a complex factor (beam shaping weight) and then added together. The interference signal can thus be suppressed by pre-whitening or setting a spatial zero (nulling). In addition, the useful signal can be amplified by suitable superimposition (e.g. eigenbeamformer).

A GNSS signal typically consists of a modulated code signal which is mixed up to a target frequency (e.g. L1 band) with the aid of a carrier signal. The code signal contains the PRN code and (if available) a navigation message. A conventional GNSS receiver removes the carrier signal and uses the code signal to determine the pseudo-range and thus the position. For such a receiver, it is only relevant that the carrier signal can be removed, but not what (absolute) phase position it has at a certain point in time. However, the carrier phase or the carrier phase position at a specific point in time is still used for highly accurate positioning. Spatial filtering in conjunction with interference signal suppression changes the carrier phases of the satellite navigation signals. The carrier phase positions of the various satellite navigation signals can no longer be related to a spatial point after interference suppression. However, this is necessary for determining the position using the carrier phase. The code phase is less important, since its accuracy (typically about 3 m) is significantly inferior and the code phases are shifted by at most one wavelength of the carrier phase (typically about 19 cm) by spatial filtering.

Thus, it is a drawback of the interference signal suppression that the carrier phase of the input signals is distorted by the superposition of the input signals dependent on the direction, and an exact determination of the original carrier phase is thus no longer possible. However, the exact carrier phase (as an absolute value) is needed for the positioning of the receiver when used in high-precision positioning algorithms such as e.g. Real Time Kinematics (RTK) or Precise Point Positioning (PPP). Moreover, the carrier phase information serves to determine the direction of incidence of the received signal. In this respect, however, the relative value is sufficient, i.e. the carrier phase shift at the position of the individual antennas of the array relative to each other.

In prior art, two approaches exist for a correction of the distorted carrier phase.
1. The directionality of an antenna array can be characterized by the so-called spatial phase signature (steering vector). This describes the phase position of the incident signal at the different antenna elements relative to a fixed point. If the spatial phase signature of the incident signal is known, the phase error can be calculated and the carrier phase of the incident signal can be corrected.
   Various approaches exist for calculating the phase signature:
   a. The multi-antenna system is measured in a measuring chamber and the direction-dependent phase signature (or a correction variable derived therefrom) is stored in a table. If the directions of incidence of the signals and the position of the antenna array are known, the phase error can be determined and corrected.
      The disadvantage of this approach is that the antenna array has to be measured. This is mostly only possible at high cost in an antenna measurement chamber. In addition, the spatial phase signature of the antenna array changes very much with changes in the near field, so that a measurement is only valid for a predefined environment. In addition, the directions of incidence of the signals must be known and the antenna array used must be calibrated. Both are associated with additional effort and therefore increased costs. (Calibration is required to compensate for the different signal propagation times in the front end and the other components).
   b. Assuming that the useful signal has the highest power, the spatial phase signature can be estimated during the operation of the receiver. Without an interference signal, this assumption is fulfilled for GNSS signals after correlation with the typical satellite spreading code. However, if an interference signal is present, it must first be suppressed in order to estimate the phase signature. In turn, mitigation by means of pre-whitening or setting a spatial zero changes the phase vector. Known methods first determine the changed phase vector and then calculate the mitigation.
      This approach has the disadvantage that the mitigation must be subtracted from the estimated phase signature. As a result, the previously suppressed interference signal is added back into the estimate so that the estimated phase signature deviates from the actual phase signature of the incoming signal. This in turn changes the calculated correction of the carrier phase. This approach only works as long as either the interfering signal is very small or the phase vector of the incident signal is perpendicular to the phase vector of the interfering signal.
2. The arrangement of the array's antenna elements is restricted to fixed systems. This usually assumes a point-symmetrical arrangement of the antenna elements with the symmetry point in the center of the array. Depending on the approach, there must also be an antenna element in the center of the array or the choice of weights must be restricted. Assuming idealized, isotropic antenna elements, an influence on the carrier phase can thus be completely prevented. If the antenna elements deviate only slightly from this ideal, this results in a phase error of the carrier phase which is, however, relatively small.
   Here, the disadvantage is that the arrangement of the antenna elements is predetermined. This means that not just any antenna arrays can be used. If, in addition, the antenna elements depend on idealized, isotropic rays, the carrier phase is again distorted more. In addition, known approaches reduce the number of the degrees of freedom in the suppression of interference signals by the factor of 2. This means, for example, that an antenna array with four elements instead of three can only suppress one interference signal.

US-A-2002/0169578 discloses a method for suppressing interference signals and determining the position of a satellite navigation signal receiver. The signal resulting from the interference signal suppression is processed in a conventional, i.e. code phase-based GNSS receiver. According to the known method, a common beamforming is performed for all satellite navigation signals, which gives rise to individual, direction-dependent phase errors for the different satellite navigation signals.

The interference signal suppression and amplification of a useful signal using a combination of different methods is known from WO-A-02/051028. Stabilization of the carrier phases after interference signal suppression is performed in this method. This method is therefore also only suitable for code phase-based GNSS receivers.

US-A-2017/0102445 relates to the combination of antenna signals from an antenna array into a single signal (beamforming). According to the known method, the resulting signal is compared with the signal of a reference antenna, wherein the weights are adjusted such that the useful signal is the strongest and differs as little as possible from the signal at the reference antenna. However, a comparison with the reference antenna is only possible as long as the useful signal at the reference antenna can still be used. If there is an interference signal in addition to the useful signal, which is significantly stronger than the useful signal, this signal can no longer be evaluated with a single antenna and a comparison with the reference antenna is therefore no longer possible.

WO-A-98/032239 describes a method for interference signal suppression using notch filters and the subsequent combination of the filtered signals for additional spatial interference signal suppression by means of spatial filtering. It is attempted to ensure the amplification of the individual signals as in the case of an isotropic antenna, which means that the satellite signal is, as far as possible, not attenuated by the filter.

It is an object of the invention to further reduce the negative influences of interference signal suppression of satellite navigation signals n the measurement of the carrier phase.

To achieve this object, the invention proposes a method for reducing the effects of interference suppression on the measurement of the carrier phases of satellite navigation signals at the location where they are received, in which method
a one- or multi-dimensional antenna array with a plurality of receiving antennas is provided,
satellite navigation signals received by the receiving antennas are processed in a signal processing unit,
an eigenbeamformer is applied to one or each of the received satellite navigation signals and parameters describing the same are calculated,
the parameters of the eigenbeamformer of the one satellite navigation signal or of each satellite navigation signal are measured or determined at times when no interference suppression is to be performed,
the received satellite navigation signals are subjected to interference suppression in the signal processing unit by means of a spatial filter, i.e. by means of spatial filtering, such as a power inversion (PI) filter or a projection filter, after which the carrier phases of the satellite navigation signals are distorted,
after the interference suppression by means of the signal processing unit, the carrier phase of at least one or each of the satellite navigation signals is changed by calculating parameters from the current eigenbeamformer associated with the respective satellite navigation signal and the preceding eigenbeamformers associated with the respective satellite navigation signal, so that the distortions of the carrier phases resulting from the interference suppression are corrected.

With the concept according to the invention, the distortion of the carrier phase by the application of an interference suppression method is eliminated by applying an eigenbeamformer to each received satellite navigation signal or by proceeding in this way for at least one of the received satellite navigation signals, i.e. initially when no interference suppression has to be carried out. If an interference with the satellite navigation signals then occurs after, for example, the last application of an eigenbeamformer without interference suppression of the satellite navigation signals, the interference suppression is carried out in order to subsequently or simultaneously with the interference suppression correct the carrier phase using the resulting distorted carrier phase and the preceding eigenbeamformers. In other words, the eigenbeamformer applied to a satellite navigation signal before interference suppression serves as a source of information for the description of the carrier phase before interference suppression. Assuming that the spatial constellation of the antenna array and satellite has not changed, the distorted carrier phase can then be changed by calculating parameters from the current and preceding eigenbeamformers, so that the distortions of the carrier phase caused by the interference signal suppression are corrected.

If the constellation of the antenna array and satellite has changed during the interference suppression period, which will be the normal case, as the satellites continue to move during the interference suppression period, this can also be taken into account as the orbital curves of the satellites are known.

The interference suppression (together with the eigenbeamformers) thus changes, in dependence on the directions of incidence, the (measurable) carrier phases in the sum signals to be calculated per satellite navigation signal. This change has to be compensated for. For this method, it is not necessary to know the absolute carrier phase in the interference-free state. All that needs to be known is (indirect) information about the direction of incidence of the satellite signal so that this change can be calculated accordingly. This information is contained in the eigenbeamformers at times when no interference suppression is performed.

Even without interference suppression, there is still a certain amount of freedom in the design of the eigenbeamformer. The eigenbeamformer (as a vector) can only be determined down to a complex factor. To enable the position to be determined from the measurable phase positions of the sum signals, the eigenbeamformers of all satellites must be of the same shape (e.g. antenna 1 is set to positive real value).

The parameters from the current and the preceding eigenbeamformer are calculated, but the change in the carrier phase mentioned here is achieved by manipulating the current eigenbeamformer. The previous correction of the carrier phase is therefore already included in the last eigenbeamformer and is therefore accumulated.

In a receiver that performs the method according to the invention, the input signals (satellite navigation signals) received per satellite by the receiving antenna are mixed at two different points. Firstly during interference signal suppression, which mixes the signals such that the interference signal is canceled out, and then again during beamforming, in which the already mixed signals are mixed again individually with each satellite navigation signal so that the satellite navigation signal to be used is amplified as much as possible.

Accordingly, in an exemplary concrete implementation of the invention, the signal path may be as follows, assuming that N is the number of receiving antennas of the antenna array, Mᵢ with i=1, 2, . . . is the individual satellite navigation signals received and Sᵢ with e=1, 2, . . . is the sum signal for the satellite navigation signal Mᵢ resulting after correlation and beamforming.

Antennas 1, 2, . . . , N receive the satellite signal M₁ and transmit it through antenna channels 1, 2, . . . , N in the front end. This is followed by an analog-to-digital conversion (ADC) for each channel in order to perform the interference signal suppression. Each channel, i.e. the signal of each channel, is correlated with the PRN code of the satellite navigation signal Mᵢ. Beamforming is performed after each correlation and then the sum signal Sᵢ assigned to the satellite navigation signal M₁ is formed.

The same procedure is followed with each additional satellite navigation signal Mᵢ received, so that a sum signal Sᵢ corresponding to this satellite navigation signal is obtained.

There are therefore a total of N*M correlators and consequently Sᵢ different sum signals after beamforming with the number of different beamformers equal to the number of satellite navigation signals received.

If interference signal suppression is performed, the correlation can no longer be said to correlate with the antenna signal of antenna 1, for example. At this point, each of the N channels contains a mixture of all N antenna channels, which have been mixed such that the interference signal is canceled out as far as possible. Mathematically, this is a complex linear combination of the antenna channels. The correlation with each PRN code is still performed for N channels, respectively. Thus, after interference signal suppression, N different signal channels are still required.

The invention thus proceeds, for example, such that the respective interference suppression is defined by a set of signal processing parameters for application to the satellite navigation signals to be suppressed, this set of parameters changing when interference affecting the satellite navigation signals, which interference arises from interference signals in the vicinity of the receiver or due to infrastructure in the vicinity of the receiver, changes, and that, when the interference changes,
the parameters of a new eigenbeamformer are calculated for the at least one satellite navigation signal or for each satellite navigation signal, so that the previously calculated phase of the at least one satellite navigation signal or of each satellite navigation signal results when the respective new eigenbeamformer is applied, and
to compensate for the change in the phase of the at least one satellite navigation signal or each satellite navigation signal calculated by the new eigenbeamformer resulting from the changed interference suppression parameter set, the parameters of the relevant new eigenbeamformer are further changed to correct the phase by shifting the same, i.e. by rotating the phase.

For example, to define the receiving location, one can proceed such that the parameters of each eigenbeamformer may define complex weights with which the respective signals output by the receive antennas are weighted, and that either one of the receiving antennas is selected as the reference location of the antenna array representing the location of reception, the weight for that receiving antenna being selected to be a positive real value (e.g. 1), or a position within the antenna array which does not coincide with one of the receiving antennas is selected, the weights for the receiving antennas of the antenna array being selected such that the carrier phase of the sum signal (after weighting) corresponds to the carrier phase of the satellite navigation signal belonging to the eigenbeamformer at said position, i.e. the carrier phase at a virtual antenna at this position. It should be noted that the weights of the eigenbeamformers are complex. If a receiving antenna is weighted with 1, this does not mean that all other receiving antennas are given a weight of 0, but merely that the signal from the corresponding receiving antenna is let through without a phase change. If the weight were 1i (90°) or 0.7+0.7i (45°), for example, the phase would be rotated, i.e. shifted, by 90° or 45°, respectively.

In an advantageous embodiment of the invention, the method may provide that the parameters of the eigenbeamformer define complex-valued weights with which the respective signals output by the receiving antennas are weighted, and that either one of the receiving antennas is selected as the reference position, the weight for this receiving antenna being selected to be a positive real value (e.g. 1) or a position within the antenna array is selected which does not coincide with one of the receiving antennas, the complex-valued weights for the receiving antennas of the antenna array being selected such that the carrier phase of a resulting sum signal after weighting is equal to the carrier phase of the satellite navigation signal associated with the eigenbeamformer, which would reach an antenna at said reference position of the antenna array.

In a further suitable embodiment, it can also be provided that the beamforming weights of the eigenbeamformer are initialized with undisturbed satellite navigation signals in that the satellite navigation signal is let through unchanged at the reference position, so that no direction-dependent carrier phase error arises in relation to this reference position as a result of the beamforming, wherein in a subsequent interference suppression, the eigenbeamformer to be calculated is adapted on the basis of the previous eigenbeamformer with the goal that the phase of a resulting sum signal continues to be equal to the carrier phase of the satellite navigation signal at the reference position.

The resulting sum signal is typically the sum of the complex-valued, weighted interference-suppressed receiving antenna signals, wherein these interference-suppressed receiving antenna signals are a complex-valued linear combination of the individual digitized receiving antenna signals and are calculated from the input signals by applying the interference suppression, and wherein the eigenbeamformer defines the complex-valued weights of the sum.

In the method according to the invention, a one- or multi-dimensional (e.g. two- or three-dimensional) antenna array with several receiving antennas is used. The signals received by the receiving antennas and present at their outputs (channels of the antenna array) are processed in a signal processing unit using, for example, a signal processor. First, interference suppression is performed, whereby the individual satellite navigation signals can be separated from the interference signal. Unfortunately, this procedure causes the information about the phases with which the individual satellite navigation signals reach the antenna array to be lost, as the signals from the individual receiving antennas are made in-phase during interference suppression. This must now be compensated for in the calculation of eigenbeamformers, wherein one eigenbeamformer is generated/calculated for each satellite navigation signal. The resulting phase error is not compensated by the calculation of the eigenbeamformer, but by a term that is in turn applied to the eigenbeamformer as a phase rotation or phase shift

Any change in the interference of the satellite navigation signals resulting from the environment or movement of the receiver changes the calculation of the eigenbeamformers. In chronologically successive sections or at successive points in time, the interference suppression as well as each eigenbeamformer is recalculated. In this iterative process, the procedure is such that the eigenbeamformer to be recalculated at a point in time x is calculated such that the phase resulting therefrom initially remains unchanged relative to the previously (i.e. at the point of time x−1) calculated phase. In doing so, the (temporary) phase change resulting from the change of the interference (between the points of time x−1 and x) and thus from the recalculated interference suppression is cancelled. Further, the (temporary) phase change caused by the new change in interference suppression has to be compensated for, which is done by means of a phase rotation applied to the phase calculated by the new eigenbeamformer.

The method according to the invention requires a multi-antenna receiver with interference suppression and subsequent beamforming by means of eigenbeamformers. In a case without interference, the method initiates the beamforming weights such that the signal of the reference antenna (an element of the array defined in advance) is let through unchanged (complex-valued weight=1). In relation to this element, no direction-dependent phase error occurs with this procedure due to beamforming. If an interference signal is present, the eigenbeamformer to be calculated is adjusted on the basis of the previous eigenbeamformer with the goal of ensuring that the phase of the resulting sum signal (after application of the eigenbeamformer) still corresponds to the phase of the signal at the reference antenna (before application of the interference suppression).

According to the invention, the carrier phase is thus changed after interference suppression, so that it is ensured that after interference suppression, the carrier phase behaves in the same way as it does in the undisturbed case. This means that a carrier phase measurement which, for example, refers to receiving antenna 1 in the undisturbed case, can also refer to receive antenna 1 in the disturbed case. However, the measured carrier phase changes over time as the antenna array and the satellite(s) move relative to each other.

According to the invention, the adjustment is carried out in a two-stage method:
1. The parameters of the new eigenbeamformer are adapted to those of the previous eigenbeamformer as described above. At the same time, the (temporary) phase change caused by the previous change in interference suppression is canceled.
2. The (temporary) phase change caused by the (new) change in interference suppression is compensated for by means of phase rotation applied to the new eigenbeamformer.

The method according to the invention calculates the correction of the distorted carrier phases in a multi-antenna receiver from the current and the last eigenbeamformer as well as the current and the last interference suppression matrix. This calculation is performed without information about the antenna array used and is therefore virtually “blind”. A two-stage method is used, which applies the calculated phase correction directly to the beamformer used. In contrast to prior art, the method according to the invention does not calculate the spatial phase signature. The calculation thereof is heavily compromised by interference signals. In contrast to a comparable prior art method, the method according to the invention can also be used in receivers that use a projection filter for interference suppression. In addition, the method according to the invention can also be used in receivers in which the eigenbeamformer is calculated on one data set and only applied to the next data set.

Compared to the known method mentioned above under 1a, the invention has the advantage that the method works blindly, i.e. it does not require any measurement of the antenna array. In addition, no knowledge of the direction of incidence of the signals is required.

In contrast to the method mentioned above under 1b, according to the invention the spatial phase signature does not have to be calculated explicitly. Instead of an inversion of the interference suppression, only the change in interference suppression has to be taken into account. This allows the method to be implemented also in environments with strong interference signals. Furthermore, a drift of the phase correction is significantly reduced thereby.

With respect to the known method described under 2, the invention has the advantage that the arrangement of the antenna elements can be optional. Furthermore, the performance of the method according to the invention is not impaired, if the antenna elements deviate from the ideal of an isotropic antenna.

The invention can be used, for example, to determine the distance of a receiver for satellite navigation signals to a satellite, wherein the method described above is performed to reduce the effects of interference suppression on the measurement of the carrier phases of satellite navigation signals at the location of their reception and wherein the so-called pseudo-distance of the receiver to the satellite is calculated on the basis of the calculated carrier phase of the satellite navigation signal.

The invention can be used, for example, to determine the position of a receiver for satellite navigation signals, the method described above being performed to reduce the effects of interference suppression on the measurement of the carrier phases of satellite navigation signals at the location of their reception, the position of the receiver being determined on the basis of the distances of the receiver to several satellites.

Possible commercial applications include GNSS receivers that require high accuracy, GNSS reference stations and GBAS stations.

The invention is described in more detail below with reference to embodiment and with reference to the drawing. In detail, the Figures show:

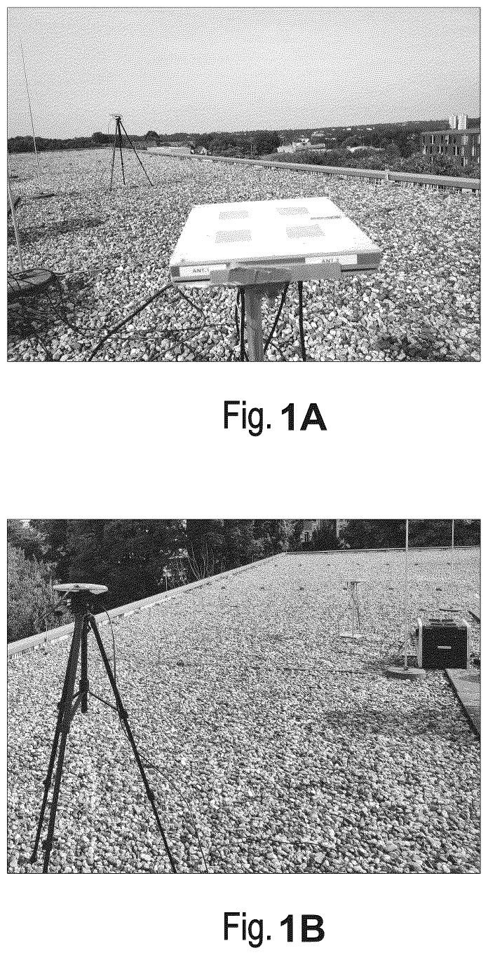

FIGS. 1a and 1b show a measurement setup on the roof of the UMIC research center at RWTH Aachen University. The antenna array at the front in FIG. 1a and at the rear in FIG. 1b (DLR UNITAS) is used to receive the satellite signals and the antenna at the rear in FIG. 1a and at the front in FIG. 1b is used to emit the interference signal.

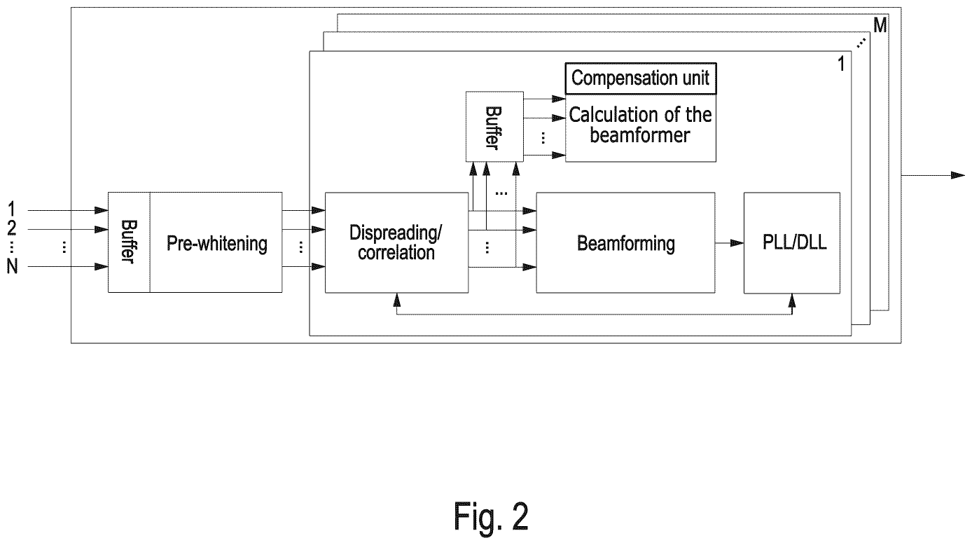

FIG. 2 shows a signal tracking structure of a multi-antenna receiver with N antenna channels and the proposed compensation unit, where M is the number of satellites.

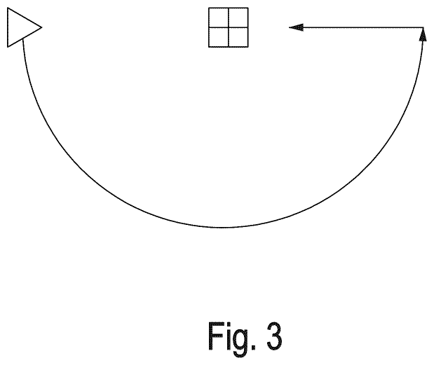

FIG. 3 shows the movement of the interfering antenna around the UNITAS antenna array in scenario 2.

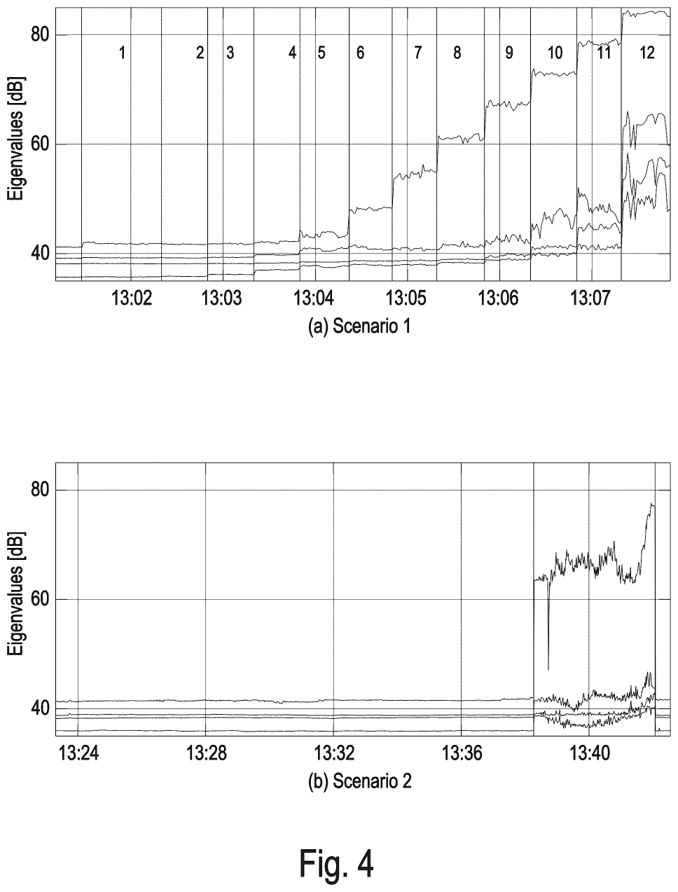

FIG. 4 shows the power of the eigen-values of the precorrelation covariance matrix estimated by the receiver.

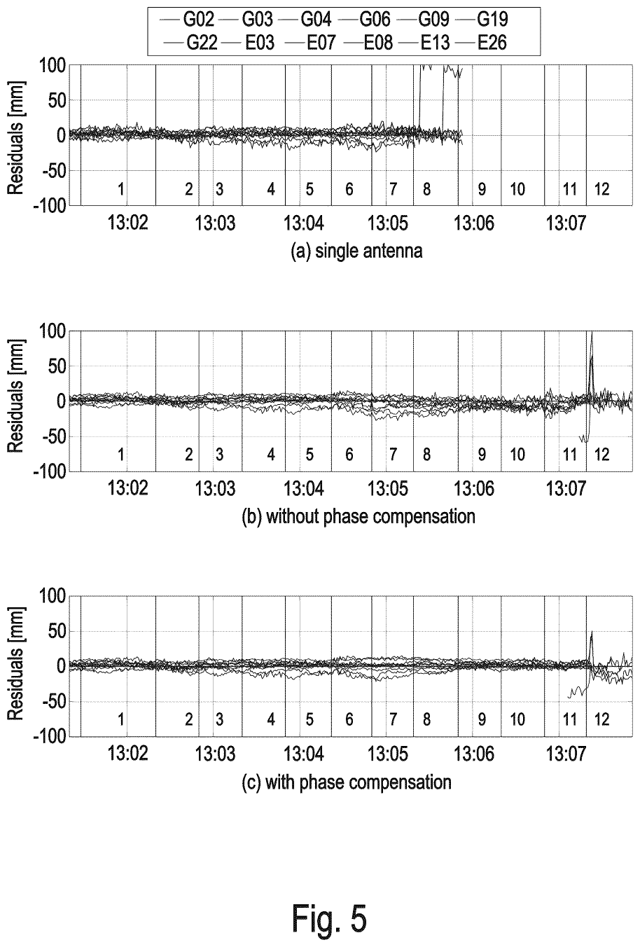

FIG. 5 shows scenario 1: Residuals of the carrier phase over the UTC time.

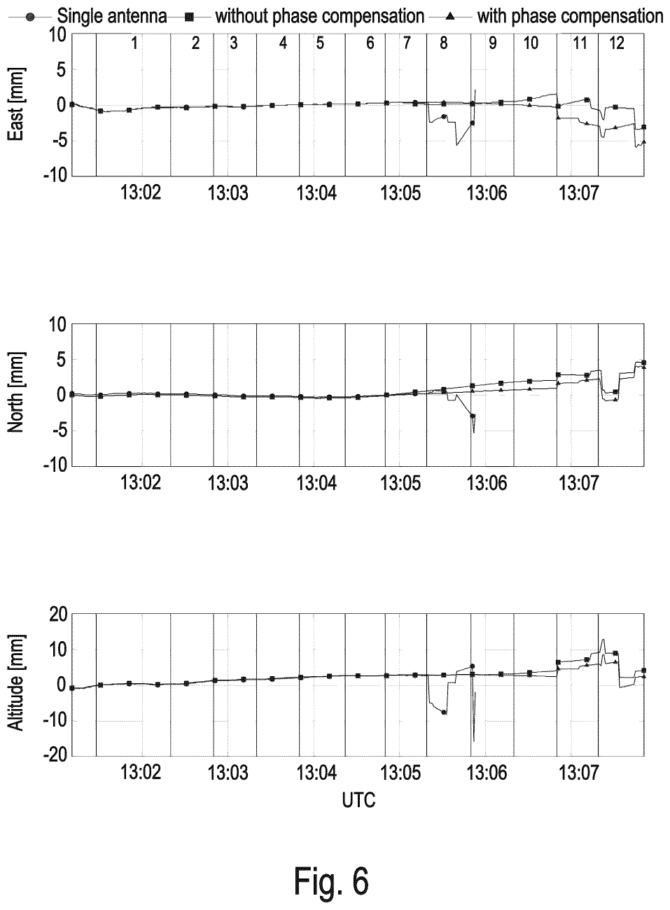

FIG. 6 shows scenario 1: Position deviation over time.

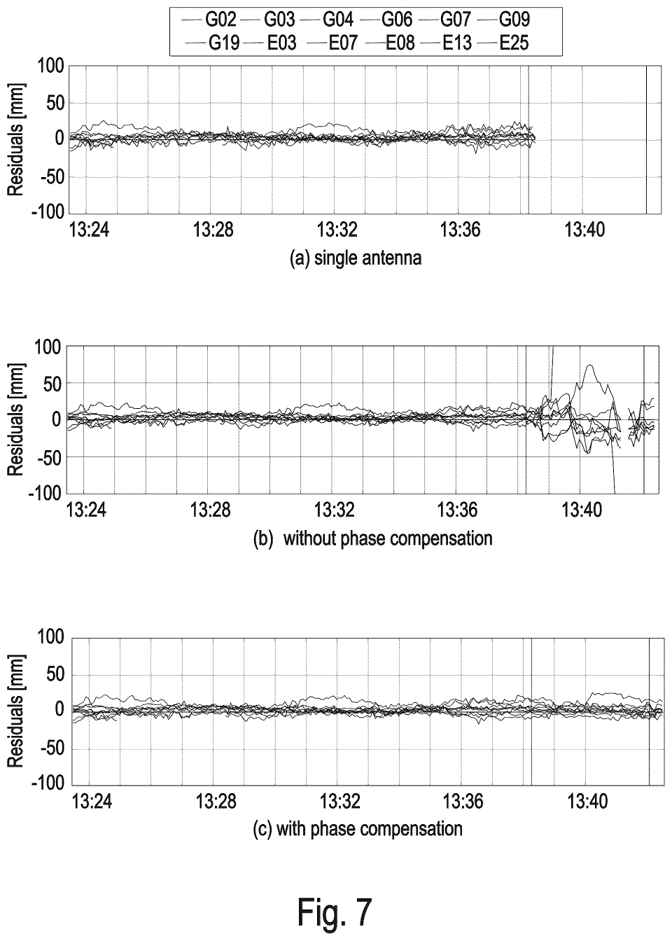

FIG. 7 shows scenario 2: Mobile jammer with constant power level.

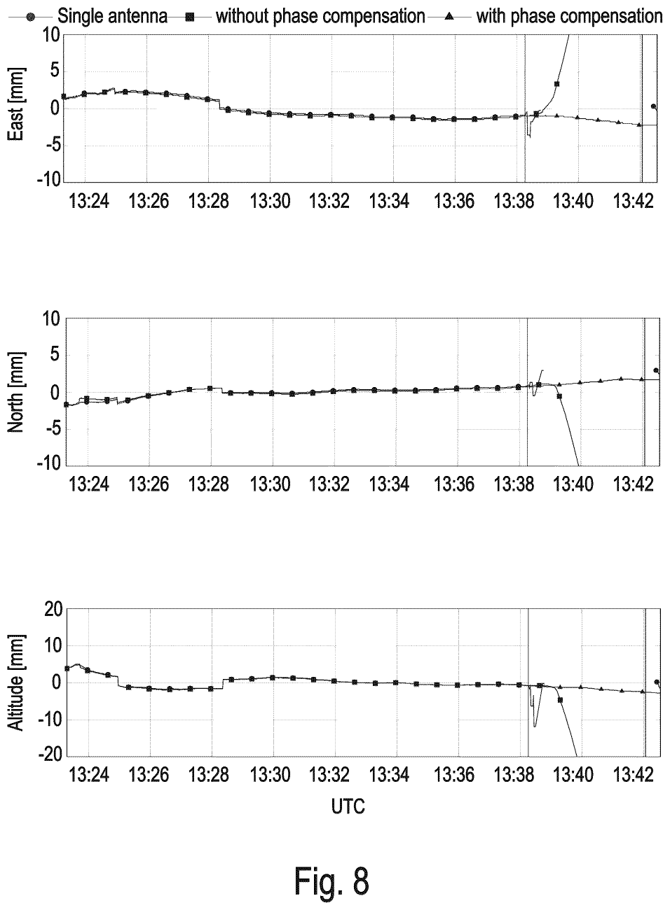

FIG. 8 shows scenario 2: Position deviation over time.

Global Navigation Satellite Systems (GNSS) are often used to determine position and measure time. The systems are used by almost all land, air and water vehicles to navigate. With the increasing number of private and commercial drones and the emergence of autonomous vehicles, the number of systems that rely on GNSS will continue to grow. Therefore, it becomes ever more important to ensure the availability and integrity of the position, velocity and time solution (PVT) also in case of interferences, disturbances or even spoofing. Moreover, the new applications require a higher precision of the PVT solution. This requirement can be met by the technologies of precise point positioning (PPP) and real-time kinematics (RTK). A key element of these methods is the inclusion of carrier phase measurements into the PVT estimation. Carrier phase measurements enable much more precise distance measurements, since the wavelength of a GNSS carrier, e.g. 19 cm for GPS L1, is much shorter than the corresponding length of a PRN code chip when propagating in space, e.g. 293 m for the C/A code of GPS L1.

An advanced approach for a protection against jamming and spoofing is the use of adaptive antenna arrays and the use of signal processing in the spatial domain. The antenna arrays can be used to detect and mitigate jammers [1] and spoofers [2], [3]. In addition, an antenna array enables the increase of the C/NO value of a satellite signal by directing a beam in the direction of arrival (DoA). Mitigation is generally performed by means of spatial filters such as the power inversion (PI) filter or the minimum variance distortionless response (MVDR) filter. These filters can be classified into deterministic and blind approaches. In a deterministic approach, the steering vector of the incoming satellite signal must be known. The steering vector of an impinging signal is its spatial signature which includes the phase information of the signal at each antenna element. In order to obtain the steering vector, the receiving pattern of the antenna must be known. In practice, a blind approach is often desired. A blind approach works without previous knowledge of the antenna gain/phase matrix, the calibration matrix and the direction of arrival of the interference. However, conventional implementations of blind spatial filters and beamformers induce an error into the carrier phase measurements.

The problem of the induced error in carrier phase measurements has already been addressed by other researchers. In the literature, two different strategies for the mitigation of the phase error caused by the blind spatial filtering can be found: One strategy aims at preserving the continuity of the phase measurement in disturbed scenarios. Jia et al. [4] have presented such an algorithm for this purpose that works well for short-time scenarios. However, Jia et al. have not validated the proposed algorithm by recorded real world signals and evaluated the effects of the occurring phase errors on the positioning solution. In particular, the stability of the carrier phase measurements over short periods is problematic. Further studies show that approaches implementing this strategy can generally not preserve the continuity of the phase for long periods [5]. The second strategy is based on the implementation of additional restrictions of the spatial filter in an effort to avoid phase errors. This approach was demonstrated by Daneshmand et al [6] both in simulations and with recorded signals, where its advantages over a standard implementation became clear. However, the additional restrictions reduce the degrees of freedom of the spatial filter by half. Therefore, an antenna array would need twice the number of antenna elements to suppress the same number of jammers as the standard implementation. Furthermore, the algorithm only works with centrosymmetric array geometries, i.e. it cannot be applied directly to real antenna arrays without significant performance degradation due to asymmetries in the antenna characteristics caused by imperfections, tolerances, influences of objects in the near field or installation problems.

The above-mentioned limitations of the prior art were the reason for the research work described in [7] and [5]. In [7], the induced carrier phase error was evaluated for four different implementations of a spatial filter. The analysis was performed in three different scenarios to characterize the error both in the absence and presence of an interference signal. In addition, the influence of the antenna was evaluated using an isotropic antenna and a simulated antenna array diagram. The results show that the MVDR filter produces the smallest phase error. It can be shown that this filter is theoretically even free of carrier phase distortions [4]. The simulations carried out were based on the assumption that the approach has imprecise knowledge. However, it is still a deterministic approach that requires a priori knowledge. The three other approaches in [7] are blind. In these approaches, the carrier phase distortion depends on the DoA of the satellite and the DoA of the interference signal. One approach was to sum the incoming signals after suppressing the interference, i.e. to use beamforming with a one in each line. This approach only leads to a low phase distortion, but suppresses satellite signals at low altitudes. Nevertheless, even with these approaches, PPP/RTK remains a challenge in rapidly changing environments. In [5], these results were used to develop two new blind approaches to reduce the carrier phase error in spatial filtering. The basic idea of these approaches is to reduce the distortion of the tracked carrier phase by comparing the mean phase of the applied beamformer either with the previous beamformer or with the beamformer of the above approach, which is known to have little influence on the phase. The reduction of the carrier phase error by these approaches is promising, but the evaluation was limited to numerical simulations with synthetic satellite signals. The approaches were not tested with realistic signal data, and what is more, the effect of the phase error on the positioning solution was not examined.

The proposed invention extends the research work of {7] and [5] to practical experiments with recorded realistic signals and with implementation of a RTK positioning algorithm. The analysis in [7] and [5] focused on the carrier phase offset caused by the adaptive spatial filtering on the signal level. The proposed invention studies the resulting effect of such an error on the RTK positioning solution. For this purpose, GNSS signals from realistic scenarios are recorded by a software-defined radio system (SDR) and processed by a software receiver. The observables of the receiver are then transferred to the RTKlib [8], an open source program package for GNSS positioning, to obtain a RTK position solution and to evaluate the induced error in the positioning area. The filtering and the averaging of the carrier phase error performed in the carrier tracking loops of the receiver are naturally into account in this approach. The performance of the carrier phase measurements (carrier area) and the positioning solution is analyzed in different scenarios reaching from interference-free to moving jammers. The scenarios are treated with the classical implementations of spatial filtering and the approach proposed in [5]. The description concludes with a recommendation as to which approach is suitable for RTK positioning in order to perform spatial filtering of interference, multipath or spoofing signals. Using the results obtained, the invention aims to close the gap in the use of GNSS antenna array receivers with RTK positioning techniques, especially considering the limitations arising from real-world shortcomings. It will pave the way for the use of GNSS group receivers in applications that require a combination of high positioning accuracy and high reliability.

### Note:

The following notation is used in this description:
bold lower case letters stand for vectors
bold upper case letters stand for matrices
the symbols^{-T} and ^{-H} stand for transposition and hermitian transposition respectively
arg{-}stands for the angle of a complex number
E[-] and var[-] stand for the statistical expected value and the variance respectively

### System Model and Spatial Signal Processing

This section presents the signal model and the theoretical background for the spatial filters and the beamformer.

### Signal Model

An antenna array with N antennas is assumed. This group receives M satellite signals and L interference signals. The incoming signal reads as follows:

$$\begin{matrix}{ℂ}^{N \times 1} ∋ x ( t ) & = & {\sum }_{m = 1}^{M} {Ca}_{m} {s}_{m} ( t ) + {\sum }_{l = 1}^{L} C \text{?} ( t ) + n & ( 1 ) \\ & = & s + j + n & ( 2 ) \\ & & & \end{matrix}$$

$$\text{?} \text{indicates text missing or illegible when filed}$$

aₘ∈C^{N×1} and aₗ∈C^{N×1} describe the steering vectors of the satellite and the interference signals respectively. A steering vector is the spatial signature of a signal and depends on the direction of arrival (DoA) of the incoming signal and the direction of the antenna array. For a simplified, isotropic antenna group, a=(e⁻¹, . . . , e^{-ik}^{^{T}}^{r}^{_{N}}) describes the steering vector of an incident wave. k is the wave vector and r1, . . . , rN describe the spatial positions of the antenna elements. In practice, the steering vector deviates (in phase and amplitude) from this simplified model, as the antenna elements of the arrays are generally not isotropic or even not azimuthally invariant, which is due to the electromagnetic coupling of the array elements. Also some other practical effects such as manufacturing tolerances and the presence of other objects in the near field result in the antenna patterns of an installed array deviating from the diagrams calculated by means of antenna modeling tools or measured in an anechoic chamber. Equation (1) takes some of these effects into account by the term C. This matrix models different cable lengths and component tolerances in the N antenna processing channels as well as the cross-talk between different channels. It is the same for all incoming signals and is, in particular, not influenced by the DoA of a signal. Its inverse value C⁻¹ is referred to as a calibration matrix.

It is pointed out at this point that the steering vector also depends on the choice of the reference coordinate system. The origin of this reference system is the spatial reference for the modeled system sₘ(t) and j(t). If not indicated otherwise, the origin is the center of the antenna group which is determined as the mean value of all antenna positions. sₘ(t) describes the satellite signal. It contains the data bits, the spread code and the carrier signal. jₗ stands for the interference signal and n∈C^{N×1} stands for the additive noise proportion. A Gaussian noise with a mean value of zero and a variance of σₙ² is modeled.

### Spatial Filter and Beamformer

The combination of the received antenna signals offers the possibility of amplifying or suppressing various DoAs. For this purpose, the received signals are multiplied by a complex number (phase and amplitude change) and added together. The beamformed signal can be expressed as

$$y = {w}^{H} x . \qquad ( 3 )$$

The weight vector w is defined by the user's needs. A common method for suppressing unwanted signals is to use the minimum variance filter (MV), which minimizes the variance of the unwanted signals in the output signal. Assuming that the unwanted signals have a mean value of zero and are uncorrelated with the satellite signal, it can be written:

$${min}_{w} var [ {w}^{H} ( j + n ) ] = 𝔼 [ {\vert {w}^{H} ( j + n ) \vert}^{2} ] = {w}^{H} 𝔼 [ ( j + n ) {( j + n )}^{H} ] w = {w}^{H} {R}_{j + n} w \qquad ( 4 )$$

Rⱼ₊ₙ is the covariance matrix of the unwanted signal and the noise. To exclude the trivial solution w=0, a further condition must be added. The additional condition w^{H}aₘ=1 results in the MVDR filter. The solution for this filter is given by:

$${w}_{MVDR} = \frac{{R}_{j + n}^{- 1} {a}_{m}}{{a}_{m} {}^{H} {R}_{j + n}^{- 1} {a}_{m}} \qquad ( 5 )$$

The GNSS satellite signals are far below the background noise. Therefore, the covariance matrix of the unwanted signal can be approximated without prior knowledge by:

$${\tilde{R}}_{j + n} = \frac{1}{K} {\sum }_{k = 1}^{K} x [ k ] {x [ k ]}^{H} , \qquad ( 6 )$$

where K describes the number of samples used and x[k] represents the read samples at time tₖ=kT with the sampling interval T.

Estimating the steering vector for the desired satellite signal is more difficult: If the reception pattern of the receiver system, the location and the position of the antenna array are known, the DoA and the steering vector of the impinging signal can be calculated using the ephemeris data. This approach is classified as a deterministic filter. In practice, this approach is quite demanding due to the temporal changes in the required information. A promising attempt to jointly estimate the time-varying components is described by Zorn in [9] and [10].

### Eigenbeamformer

Another way of estimating the steering vector is to estimate it according to the dispersion/correlation. Correlation amplifies the useful signal beyond the background noise, making it possible to extract its spatial signature.

This approach can even be used in the presence of an interference signal that is superimposed on the satellite signal. In order to suppress heavy interferences, a spatial filter P Rⱼ₌ₙ^{-1/2} is applied before correlation. This process is referred to as pre-whitening. The filtered signal reads as follows:

$$\overline{x} ( t ) = Px ( t ) = Ps + Pj + Pn \qquad ( 7 )$$

The signal after correlation can be expressed as:

$${y}_{m} = {G}_{m} {PCa}_{m} + {n}_{pc , m} \qquad ( 8 )$$

where the factor Gₘ represents the scaling of the correlation with the local replica and n_{pc,m} is the noise after the correlation process. This noise includes both the other satellites and the suppressed jammers and the pre-correlation noise.

The post-correlation covariance matrix for a satellite m is as follows:

$${R}_{{y}_{m}} = 𝔼 [ {y}_{m} {{y}_{m}}^{H} ] \qquad ( 9 )$$

When calculating the eigen-decomposition and adopting the eigen-vector associated with the strongest eigen-value, the following vector is obtained:

$${b}_{m} = ( {α}_{m} {e}^{i {ϕ}_{m}} ) {PCa}_{m} + {e}_{m} \qquad ( 10 )$$

Eigen-vectors are assigned only to one scale factor which is represented by the complex term (αₘe^{iϕ}^{ₘ}) in equation (10). Typically, the eigen-vector is scaled such that it has a norm of one. However, the phase factor (e^{iϕm}) is still arbitrary. The term eₘ stands for the errors in the estimation of the steering vector.

Due to the use of the eigen-vector, this beamformer is referred to as an eigenbeamformer. The approach requires no information about the antenna group and is thus classified as a blind filter. The eigenbeamformer is described in more detail in [11] and [4]. The weighting vector for the limited MV filter with an eigenbeamformer is given by:

$${w}_{MVEig} = \frac{{P}^{H} {b}_{m}}{{{b}_{m}}^{H} {P}^{H} {Pb}_{m}} \qquad ( 11 )$$

### Phase Error and Phase Compensation Mechanisms

The above described beamformer suppresses unwanted interference signals and amplifies a desired satellite signal. This is effected by summing the phase-shifted signals. The resulting sum signal is then transmitted to the PLL/DLL which are used to measure the pseudo-distance and the carrier phase. In this section, the influence of the described eigenbeamformer on the carrier phase will be described. Moreover, two methods for reducing this effect will be presented.

### Phase Error

Mathematically, beamforming can be described by the combination of equations (3) and (1):

$$y = {w}^{H} x = {\sum }_{m = 1}^{M} {w}^{H} {Ca}_{m} {s}_{m} ( t ) + {\sum }_{l = 1}^{L} {w}^{H} C \text{?} + {w}^{H} n . \qquad ( 12 )$$

$$\text{?} \text{indicates text missing or illegible when filed}$$

The phase shift of an individual satellite signal sₘ induced by the spatial signal processing can be described as the phase of the product of the weighting vector, the inverse calibrating matrix and the true steering vector of this particular satellite.

$${Δφ}_{m} = arg \{ {w}^{H} {Ca}_{m} \} . \qquad ( 13 )$$

The induced phase shift of the MVEig-beamformer can be calculated. With equation (11), equation (13) is obtained:

$$\begin{matrix}{Δφ}_{MVEig , m} & = & arg \{ {{w}_{MVEig}}^{H} {Ca}_{m} \} & ( 14 ) \\ & = & arg \{ \frac{{{b}_{m}}^{H} {PCa}_{m}}{{{b}_{m}}^{H} {P}^{H} {Pb}_{m}} \} & ( 15 ) \\ & = & arg \{ {{b}_{m}}^{H} {PCa}_{m} \} & ( 16 )\end{matrix}$$

For technical reasons, the eigenbeamformer is usually estimated from samples of the previous iteration, while the spatial filter is applied in the same iteration in which it was generated. To take this into account, an index is added that indicates the time dependency: h or h−1 (e.g. aₕ and aₕ₋₁). In order to maintain readability, the satellite dependency will no longer be indicated, i.e. the index m is no longer shown. With these adjustments and with equation (10), equation (16) reads as follows:

$$\begin{matrix}{Δφ}_{MVEig} & = & arg \{ {[ ( {α}_{h - 1} \text{?} ) {P}_{h - 1} {C}_{h - 1} {a}_{h - 1} + {e}_{h - 1} ]}^{H} {P}_{h} {C}_{h} {a}_{h} \} & ( 17 ) \\ & = & arg \{ ( {α}_{h - 1} \text{?} ) {a}_{h - 1}^{H} {C}_{h - 1}^{H} {P}_{h - 1}^{H} {P}_{h} {C}_{h} {a}_{h} + {e}_{h - 1}^{H} {P}_{h} {C}_{h} {a}_{h} \} & ( 18 ) \\ & = & - {ϕ}_{h - 1} + arg \{ {a}_{h - 1}^{H} {C}_{h - 1}^{H} {P}_{h - 1}^{H} {P}_{h} {C}_{h} {a}_{h} \} + & ( 19 ) \\ & & arg \{ 1 + \frac{{e}_{h - 1}^{H} {P}_{h} {C}_{h} {a}_{h}}{( {α}_{h - 1} \text{?} ) {a}_{h - 1}^{H} {C}_{h - 1}^{H} {P}_{h - 1}^{H} {P}_{h} {C}_{h} {a}_{h}} \} & \end{matrix}$$

$$\text{?} \text{indicates text missing or illegible when filed}$$

### Compensation

To prevent the spatial signal processing from affecting the distance measurements, the phase error must be zero, i.e. Δφ_{MVEig}=0^{!}. The proposed compensation algorithm aims at preventing a phase jump in two consecutive estimates of the beamformer or spatial filter. Compensation is achieved by changing the phase of the estimated eigenbeamformer (10) before it is used in the beam shaping process. Mathematically, the weighting vector after compensation for the satellite is m:

$${\hat{w}}_{MVEig , m} = \text{?} \frac{{P}^{H} {b}_{m}}{{{b}_{m}}^{H} {P}^{H} {Pb}_{m}} \qquad ( 20 )$$

$$\text{?} \text{indicates text missing or illegible when filed}$$

with the compensation phase φ_{Comp}.

The compensation phase is estimated in two steps. The first step is defined by the multiplication of two consecutive eigenbeamformers:

$$\begin{matrix}\text{?} & := & arg \{ {{b}_{h}}^{H} {b}_{h - 1} \} & ( 21 ) \\ & = & arg \{ {[ ( {α}_{h - 1} \text{?} ) {P}_{h - 1} {C}_{h - 1} {a}_{h - 1} + {e}_{h - 1} ]}^{H} [ ( {a}_{h - 2} \text{?} ) {P}_{h - 2} {C}_{h - 2} {a}_{h - 2} + {e}_{h - 2} ] \} & ( 22 ) \\ & = & - {ϕ}_{h - 1} + {ϕ}_{h - 2} + arg \{ {a}_{h - 1}^{H} {C}_{h - 1}^{H} {P}_{h - 1}^{H} {P}_{h - 2} {C}_{h - 2} {a}_{h - 2} \} + & ( 23 ) \\ & & arg \{ 1 + \frac{{e}_{h - 1}^{H} {e}_{h - 2} + ( {α}_{h - 2} \text{?} ) {e}_{h - 1}^{H} {P}_{h - 2} {C}_{h - 2} {a}_{h - 2} + ( {α}_{h - 1} \text{?} ) {a}_{h - 1}^{H} {C}_{h - 1}^{H} {P}_{h - 1}^{H} {e}_{h - 2}}{( {α}_{h - 1} \text{?} ) ( {α}_{h - 2} \text{?} ) {a}_{h - 1}^{H} {C}_{h - 1}^{H} {P}_{h - 1}^{H} {P}_{h - 2} {C}_{h - 2} {a}_{h - 2}} \} & ( 24 )\end{matrix}$$

$$\text{?} \text{indicates text missing or illegible when filed}$$

The second step takes into account the changing pre-whitening matrix. It is defined by

$$\begin{matrix}\text{?} & := & arg \{ {{b}_{h}}^{H} {P}_{h} {P}_{h - 1}^{- 1} {b}_{h} \} & ( 25 ) \\ & = & arg \{ {[ ( {α}_{h - 1} \text{?} ) {P}_{h - 1} {C}_{h - 1} {a}_{h - 1} + {e}_{h - 1} ]}^{H} {P}_{h} {P}_{h - 1}^{- 1} [ ( {a}_{h - 1} \text{?} ) {P}_{h - 1} {C}_{h - 1} {a}_{h - 1} + {e}_{h - 1} ] \} & ( 26 ) \\ & = & arg \{ {a}_{h - 1}^{H} {C}_{h - 1}^{H} {P}_{h - 1}^{H} {P}_{h} {C}_{h - 1} {a}_{h - 1} \} + & ( 27 ) \\ & & arg \{ 1 + \frac{{‖ {e}_{h - 1} ‖}^{2} + ( {α}_{h - 2} \text{?} ) {e}_{h - 1}^{H} {P}_{h} {C}_{h - 1} {a}_{h - 1} + ( {α}_{h - 1} \text{?} ) {a}_{h - 1}^{H} {C}_{h - 1}^{H} {P}_{h - 1}^{H} {P}_{h} {P}_{h - 1}^{- 1} \text{?}}{\text{?} {α}_{h - 1} {a}_{h - 1}^{H} {C}_{h - 1}^{H} {P}_{h - 1}^{H} {P}_{h} {C}_{h - 1} {a}_{h - 2}} \} & ( 28 )\end{matrix}$$

$$\text{?} \text{indicates text missing or illegible when filed}$$

The following is assumed:
1) The calibration matrix and the control vector do not change significantly over three iterations, i.e. aₕ=aₕ₋₁=aₕ₋₂ and Cₕ=Cₕ₋₁=Cₕ₋₂. This can be assumed if the interval between the iterations is small compared to the movement of the satellites and the receiver. If the receiver is stationary or moving slowly, a reasonable interval for the iterations is 50 ms.
2) The error in the estimation of the eigenbeamformer is negligible, i.e. ∥e∥<<∥a∥.

These postulates result in phase compensation:

$$\begin{matrix}{φ}_{Comp} & = & {φ}_{c 1} + {φ}_{c 2} & ( 29 ) \\ & \approx & - {ϕ}_{h - 1} + {ϕ}_{h - 2} + arg \{ {a}_{h - 1}^{H} {C}_{h - 1}^{H} {P}_{h - 1}^{H} {P}_{h - 2} {C}_{h - 2} {a}_{h - 2} \} + arg \{ {a}_{h - 1}^{H} {C}_{h - 1}^{H} {P}_{h - 1}^{H} {P}_{h} {C}_{h - 1} {a}_{h - 1} \} & ( 30 ) \\ & \approx & - {ϕ}_{h - 1} + {ϕ}_{h - 2} - arg \{ {a}_{h - 2}^{H} {C}_{h - 2}^{H} {P}_{h - 2}^{H} {P}_{h - 1} {C}_{h - 1} {a}_{h - 1} \} + arg \{ {a}_{h - 1}^{H} {C}_{h - 1}^{H} {P}_{h - 1}^{H} {P}_{h} {C}_{h} {a}_{h} \} & ( 31 )\end{matrix}$$

If this compensation is applied to the beamformer (20), the result is

$$\begin{matrix}arg \{ {\hat{Δφ}}_{MVEig , m} \} & = & arg \{ {Δφ}_{MVEig} \} - {φ}_{Comp} & ( 32 ) \\ & \approx & - {ϕ}_{h - 2} + arg \{ {a}_{h - 2}^{H} {C}_{h - 2}^{H} {P}_{h - 2}^{H} {P}_{h - 1} {C}_{h - 1} {a}_{h - 1} \} & ( 33 ) \\ & \approx & - {ϕ}_{h - 2} + arg \{ {a}_{h}^{H} {C}_{h}^{H} {P}_{h - 2}^{H} {P}_{h - 1} {C}_{h} {a}_{h} \} & ( 34 )\end{matrix}$$

The phase error induced by the new weighting vector is the same as the phase error of the preceding weighting vector, however, with the phase offset being removed by the previous change of the pre-whitening filter. If it is assumed that the pre-whitening matrix has not changed in the previous iteration, i.e. Pₕ₋₂=Pₕ₋₁, the second term becomes zero, i.e. arg^{{a}^{ₕ}^{^{H}}^{C}^{ₕ}^{^{H}}^{P}^{ₕ₋₂}^{P}^{ₕ₋₁}^{C}^{ₕ}^{a}^{ₕ}^{}=0}. This can be used to prevent a phase change caused by the spatial signal processing in a changing environment.

However, the dependence on the previous weighting factor is also the greatest disadvantage of this approach: A phase error in the previous iteration is transferred to the next phase compensation. Therefore, in this compensation approach, the induced phase will drift over time. Moreover, the initial phase error must be known (or estimated).

### Signal Processing and Implementation of the Proposed Algorithm

For an analysis of the proposed compensation algorithm, GNSS satellite signals will be picked up and processed. For this purpose, the following steps are performed:
1) recording the GNSS signals with a suitable multi-channel data streamer.
2) using a software receiver to process the signals and generate code and carrier range observations in the RINEX format.
3) reading the RINEX file by means of the RTKlib to estimate a RTK position solution.

### Signal Recording

The Ettus USRP x300 platform is used to digitize and store the GNSS signals. The most important settings are:
Center frequency: 1575.42 MHz
Intermediate frequency of the digitized signals: 0 Hz (complex I&Q sampling)
Sampling frequency: 5 MHz
Number of recording channels: 4

The four channels are connected to the UNITAS antenna array developed and manufactured by DLR, which can be seen in the foreground of FIG. 1a. This is a uniform rectangular 2×2 antenna array with a distance between the antenna elements of about half a wavelength L1 (approximately λ_{L1}=19.04 cm,

$$\frac{{λ}_{L 1}}{2} = 9.52 cm ) .$$

The recorded signal samples are stored on a hard disk and are subsequently post-processed by a multi-antenna software receiver.

### Processing of the Recorded Signal

The GNSS software receiver used is implemented in MATLAB. FIG. 2 shows the function diagram of the receiver. The N input signals are buffered to estimate a spatial covariance matrix, the so-called pre-correlation covariance matrix (see equation (6)). This covariance matrix is used to estimate the pre-whitening filter matrix which serves to mitigate interference signals. The filter matrix is then applied to the input signal (see equation (7)). The despreading of the signal is performed individually for each satellite. The post-correlation beamforming works with the N outputs of the despreading/correlation unit. The outputs are buffered over a plurality of correlation epochs to calculate the covariance matrix of the post-correlation (see equation (9)). To ensure that this covariance matrix includes no signals with different pre-correlation filter matrices, the buffers for the pre- and post-correlation are synchronized. The post-correlation covariance matrix is used to calculate the eigenbeamformer weighting vector (see equation (10)). The proposed compensation approach as described in the previous sections is used to adjust the phase of the eigenbeamformer. The adjusted eigenbeamformer is applied to the output of the despreading/correlation unit, and the result is supplied into the PLL/DLL tracking loops. The PLL and DLL are implemented as in a conventional single antenna receiver (e.g. [12]). The states of the PLL and the DLL are used further to generate the pseudo-range and the accumulated Doppler range (ADR). These are stored in the RINEX observation file which is passed to the RTKlib.

### RTK Positioning

The RTKlib (version 2.4.3 b34) is used to obtain a RTK position solution from the RINEX observation file. In addition, a RINEX navigation file is downloaded so as to make the ephemeris and clock data available. The RTKlib is set such that is processes the file in the mode “Static Position” and fixes the integer ambiguity in the mode “continuous”. If the RTKlib can correct at least four integer ambiguities and the validation ratio is greater than 3, the solution is referred to as “RTK Fix”. Otherwise, it will be referred to as “RTK Float”. For further details about the options implemented, an excerpt from rtkpost.ini can be found in the Annex.

In addition, a RTK position solution requires a reference station. For the evaluations made in this application, a reference station of the satellite positioning service of the German Land Surveying & Geo Information Offices in Aachen (SAPOS®)[13].

TABLE I
Jamming events in scenario 1.

| ID | Start Time (UTC) | Stop Time (UTC) | rel. Power [dB] |
|---|---|---|---|
| 1 | 13:01:28 | 13:02:20 | 20 |
| 2 | 13:02:20 | 13:02:50 | 26 |
| 3 | 13:02:50 | 13:03:20 | 32 |
| 4 | 13:03:20 | 13:03:50 | 38 |
| 5 | 13:03:50 | 13:04:22 | 44 |
| 6 | 13:04:22 | 13:04:50 | 50 |
| 7 | 13:04:50 | 13:05:19 | 56 |
| 8 | 13:05:19 | 13:05:50 | 62 |
| 9 | 13:05:50 | 13:06:20 | 68 |
| 10 | 13:06:20 | 13:06:50 | 74 |
| 11 | 13:06:50 | 13:07:19 | 80 |
| 12 | 13:07:19 | 13:07:51 | 86 |

### Scenarios and Evaluation Steps

### Scenarios

For an evaluation, two different scenarios are considered. Both scenarios were recorded on the roof of the UMIC Research Centre of RWTH Aachen on Sep. 21, 2021. Two images of the measurement setup are shown in FIG. 1. Each scenario includes an interference signal specific to the respective scenario:
1) In scenario 1, a jammer with incrementally increasing signal power is analyzed. The direction of incidence of the interference signal on the antenna field remains constant. The interference power is increased by 6 dB after every 30 s. Table I shows the relative power of the individual stages as well as the start and stop times. FIG. 4a shows the eigen-values of the precorrelation covariance matrix calculated by the receiver. As can be seen in the Figure, the dispersion of the eigen-values can be used to estimate the power of the incoming interference signal in relation to the lower noise limit of the receiver.
2) In scenario 2, a moving jammer with a constant power level is analyzed.

The interfering antenna is moved in a semicircle around the UNITAS antenna array and then in the direction of the UNITAS antenna array. This movement is shown in FIG. 3. The movement was performed manually, so it is not as perfect as shown. The interference event starts at 13:38:16 UTC and ends at 13:42:04. Using the same relative power scale as in Table I, the jammer emits 62 dB (stage 8). However, the received power of the interference signal varies due to the movement of the antenna. The variation can be visualized by plotting the power of the eigen-values of the pre-correlation covariance matrix, as shown in FIG. 4b. It can be observed that the power of the received signal starts at a value comparable to stage 8 in scenario 1 and increases to a value comparable to stage 11.

### Evaluation:

Each scenario is processed in three different modes:
1) Single antenna: Neither pre-whitening nor beamforming is used in this mode. Instead, only the signal of the first array element is processed by the software receiver, which works like a conventional single-antenna receiver.
2) without phase compensation: In this mode, the receiver uses pre-whitening and beamforming, but does not compensate for a possible phase offset. Pre-whitening is only activated if the largest eigen-value of the pre-correlation covariance matrix is 10 dB higher that the smallest eigen-value. It is ensured thereby that the filter does not influence the carrier phase of the satellite signals, as long as no serious interferences exist. The weights of the eigenbeamformer are normed such that the first element (corresponding to antenna 1) remains equal to 1, i.e. positive and a real value. Without an interference signal, this results in a position determination similar to the single antenna mode. However, the beam-formed signal has a better C/NO, since it is superimposed on the input signal of N antennas.
3) w/phase compensation: In this mode, the receiver uses pre-whitening and beamforming, as well as the proposed algorithm for the compensation of phase deviations. As in the mode without phase compensation, the pre-whitening matrix is applied only if the largest eigen-value of the pre-correlation covariance matrix is 10 dB higher than the smallest eigen-value. The phase of the beamformer ist estimated using the proposed algorithm. For the initialization of the eigenbeamformer or if the spatial filter is not implemented, the phase of the beamformer is, however, estimated as in the mode without phase compensation, i.e. the first element of the beamformer is equal to 1.

### Results and Discussion

Scenario 1: Jammer with Incrementally Increasing Signal Power

FIG. 5 shows the residuals of the carrier phase, as they were written by the RTKlib for the three different modes: Single antenna (5a), without phase compensation (5b) and with phase compensation (5c). The diagrams only show the results for the fixed RTK solution. The start and end of each phase, as defined in Table I, are highlighted in red. Due to the interference signal, the single antenna has difficulties in phase 8 to track the satellite signals; with two or more satellites, a cycle error occurs. In the next phase (phase 9), the single-antenna receiver is no longer able to track the satellite signals and loses them all.

The use of the pre-whitening filter allows to maintain a RTK-FIX solution up to stage 12 (FIG. 5b). In stage 12, some satellites are lost and the residual values of the remaining satellites increase. The main reason for this is the clipping effect that occurs during the digitization process, as the recording system (USRP X300) does not use automatic gain control (AGC).

In this scenario, the phase compensation algorithm (FIG. 5c) performs only slightly better than the receiver without phase compensation (FIG. 5b): The residuals in stages 8, 9, 10 and 11 are somewhat lower and the jump in some residuals in stage 12 is not as large as without phase compensation. In this scenario with static receiver jammer geometry, however, phase compensation is not explicitly necessary, but not harmful either.

FIG. 6 shows the relative position offset for the three modes separately for east, north and altitude. The results are related to the middle position of the single antenna processing. Similar to the previous diagrams, it can be observed that the single antenna has difficulty tracking the signals in stage 8 (resulting in a clearly visible position offset) and loses them in stage 9. The use of the pre-whitening filter enables the estimation of an RTK-FIX solution up to stage 12. However, the receiver loses the connection to some satellites from stage 11 on, which can be recognized by the small jumps in the position estimates. In this static scenario, the drift of the position solution with and without carrier phase compensation is comparable.

Scenario 2: Mobile Jammer with Constant Power Level

FIG. 7 shows the carrier phase residuals for scenario 2 for the various processing modes. In this scenario, the power of the radiated interference signal remains constant, but the direction of arrival of the interference signals at the receiving antenna changes over time due to the movement of the interfering antenna.

Moreover, the received interference power varies at the antenna group because of the changing distance between the jammer and the receiving antenna (see 3b). The time at which the interference is activated is marked by two vertical lines in all relevant Figures.

Similar to scenario 1, the single antenna mode is not able to track the satellite signals while the interference signal is active. Using the pre-whitening filter enables the tracking of the satellite signals over the entire duration of the signal recording. In this scenario, the advantage of the proposed phase compensation algorithm can be demonstrated clearly: While, without phase compensation, the carrier residuals increase significantly during the time the jammer is active, they remain low when the proposed compensation approach is used. Without phase compensation, the RTK-FIX solution is even unavailable for several seconds.

The results for the position deviation in FIG. 8 also support the conclusion on the usefulness of the proposed approach. Without phase compensation, the position solution drifts significantly when the jammer is activated. As can be seen in the preceding diagrams, the RTK-FIX solution is even lost. In contrast, with phase compensation, the estimated position solutions only show negligible deviations which are on the same order under interference-free conditions and conditions with interferences.

In the framework of this invention, an algorithm for compensation of the carrier phase rotations is suggested, which occur in a “blind” spatial processing. In this context, “blind” means that the user does not need to have prior information about the phase-controlled antenna pattern or the front end. The proposed algorithm was tested in two different scenarios with the use of a company-owned software receiver in combination with the RTKlib, which was used to estimate a RTK solution. In the first scenario, the signal power of a jammer was gradually increased from a constant DoA and in the second scenario, a jammer with constant signal power was moved around the receiving antenna array. For both scenarios, the proposed algorithm was compared with a multi-antenna system without phase rotation compensation and with single-antenna processing.

As expected, the single antenna receiver is not able to estimate a position solution as soon as the interference signal becomes too strong. The multi-antenna system suppresses the interference by pre-whitening and is able to track the satellite signals during the interference. It generates continuous code and carrier range observations that provide a positioning solution. However, without compensation of the phase deviations, the carrier phase residuals estimated by the RTKlib start to grow in the (rapidly) changing environment (moving jammer). As a result, the RTKlib can no longer estimate an RTK-FIX solution, but only a FLOAT solution. In addition, the position solution begins to drift even though a static scenario was analyzed. The invention can mitigate this problem. The residuals of the carrier phase do not increase compared to the interference-free period, and the RTK-FIX solution can be maintained throughout the entire recorded period.

The invention makes it possible to take advantage of an antenna array (without having to rely on detailed information about the antenna pattern) together with an RTK positioning solution. It is best suited for situations in which a solution with medium or high accuracy (dm to cm accuracy) must be insensitive to interference. A very precise solution (cm to mm accuracy), comparable to a geodetic receiver that uses the variations of the antenna phase center, cannot be achieved with this algorithm. This is not surprising, as the algorithm does not use or require detailed information about the antenna pattern. An alternative solution for such a scenario would be to use a deterministic beamforming approach, but this would be highly dependent on knowledge of the amplitude and phase embedded patterns of the array antennas.

### Embodiments of the Invention are Described in the Following Passages:

1. A method of reducing the effects of interference suppression on the measurement of the phases of satellite navigation signals at the location of their reception, in which method
   a one- or multi-dimensional (two- or three-dimensional) antenna array with a plurality of receiving antennas is provided,
   satellite navigation signals received by the receiving antennas are processed in a signal processing unit,
   the received satellite navigation signals are subjected to interference suppression in the signal processing unit by means of a spatial filter, i.e. by means of spatial filtering, such as a power inversion (PI) filter or a projection filter,
   after the interference suppression by means of the signal processing unit, the carrier phase of at least one of the or each satellite navigation signal is corrected by calculating parameters of one or more eigenbeamformers, in that the carrier phase of the resulting sum signal after the application of the respective eigenbeamformer per satellite is still calculated/tracked conventionally, for example via a PLL, but the carrier phase calculated/tracked in this way has been distorted by the interference suppression, which is why this distortion is corrected by calculating the parameters mentioned here.
2. The method according to item 1, wherein the respective interference suppression is defined by a set of signal processing parameters for application to the satellite navigation signals to be suppressed, this set of parameters changing when interference affecting the satellite navigation signals, which interference arises from interference signals in the vicinity of the receiver or due to infrastructure in the vicinity of the receiver, changes, and that, when the interference changes,
   the parameters of a new eigenbeamformer are calculated for the at least one satellite navigation signal or for each satellite navigation signal, so that the previously calculated phase of the at least one satellite navigation signal or of each satellite navigation signal results when the respective new eigenbeamformer is applied, and
   to compensate for the change in the phase of the at least one satellite navigation signal or each satellite navigation signal calculated by the new eigenbeamformer resulting from the changed interference suppression parameter set, the parameters of the relevant new eigenbeamformer are further changed to rotate the calculated phase.
3. The method of one of items 1 or 2, wherein the parameters of each eigenbeamformer define complex weights with which the respective signals output by the receiving antennas are weighted, and that either one of the receiving antennas is selected as the reference location of the antenna array representing the location of reception, the weight for that receiving antenna being selected to be a positive real value (e.g. 1), or a position within the antenna array which does not coincide with one of the receiving antennas is selected, the complex weights for the receiving antennas of the antenna array being selected such that the carrier phase of the sum signal after weighting corresponds to the carrier phase of the satellite navigation signal belonging to the eigenbeamformer, i.e. the carrier phase at a virtual antenna at this position.
4. Method for determining the distance of a receiver for satellite navigation signals from a satellite, in which method
   the method in accordance with one of items 1 to 3 is performed and
   the so-called pseudo distance of the receiver to the satellite is calculated using the calculated phase of the satellite navigation signal.
5. Method for determining the position of a receiver for satellite navigation signals, in which method
   the method under item 4 is executed and
   the position of the receiver is determined using the distances between the receiver and several satellites.

### REFERENCES

[1] M. Cuntz, A. Konovaltsev, M. Sgammini, et al., “Field test: Jamming the DLR adaptive antenna receiver”, in Proceedings of the 24th International Technical Meeting of The Satellite Division of the Institute of Navigation (ION GNSS 2011), Portland, OR, USA, vol. 2023, 2011, p. 384392.
[2] M. Meurer, A. Konovaltsev, M. Appel, and M. Cuntz, “Direction-of-Arrival Assisted Sequential Spoofing Detection and Mitigation”, p. 12, 2016.
[3] A. Konovaltsev, M. Cuntz, C. Hättich, and M. Meurer, “Autonomous Spoofing Detection and Mitigation in a GNSS Receiver with an Adaptive Antenna Array”, presented at the ION GNSS+2013, Nashville, TN, USA: The Institute of Navigation, Sep. 30, 2013.
[4] Q. Jia, R. Wu, W. Wang, D. Lu, and L. Wang, “Adaptive blind anti-jamming algorithm using acquisition information to reduce the carrier phase bias”, GPS Solutions, vol. 22, no. 4, p. 99, Jul. 19, 2018, ISSN: 1521-1886. DOI: 10.1007/s10291018-0764-4.
[5] T. Bamberg, A. Konovaltsev, and M. Meurer, “Mitigation of Carrier Phase Distortions Induced by Spatial Filtering using Antenna Arrays”, in Proceedings of the 33rd International Technical Meeting of the Satellite Division of The Institute of Navigation (ION GNSS+2020), Oct. 28, 2020, pp. 3120-3131. DOI: 10.33012/2020.17707.
[6] S. Daneshmand, T. Marathe, and G. Lachapelle, “Millimetre Level Accuracy GNSS Positioning with the Blind Adaptive Beamforming Method in Interference Environments”, Sensors (Basel, Switzerland), vol. 16, no. 11, Oct. 31, 2016, ISSN: 1424-8220. DOI: 10.3390/s16111824. pmid: 27809252.
[7] T. Bamberg and M. Meurer, “Characterizing the Carrier Phase Distortions for Different Interference Mitigation Approaches using an Antenna Array”, in Proceedings of the 32nd International Technical Meeting of the Satellite Division of The Institute of Navigation (ION GNSS+2019), Miami, Florida, Oct. 11, 2019, pp. 3517-3527. DOI: 10.33012/2019. 16933.
[8] T. Takasu and A. Yasuda, “Development of the low-cost RTK-GPS receiver with an open source program package RTKLIB”, International Symposium on GPS/GNSS, Jan. 1, 2009.
[9] S. Zorn, M. Niestroj, S. Caizzone, M. Brachvogel, and M. Meurer, “Self-contained Antenna Crosstalk and Phase Offset Calibration by Jointly Solving the Attitude Estimation and Calibration Problem”, in ION GNSS 2017, Portland, Oregon, USA, Jul. 7, 2017.
[10] S. Zorn, T. Bamberg, and M. Meurer, “Accurate Position and Attitude Determination in a Jammed or Spoofed Environment Using an Uncalibrated Multi-Antenna-System”, Proceedings of the 2018 International Technical Meeting of The Institute of Navigation, p. 13, 2018.
[11] M. Sgammini, F. Antreich, L. Kurz, M. Meurer, and T. G. Noll, “Blind Adaptive Beamformer Based on Orthogonal Projections for GNSS”, presented at the ION GNSS 2012, Nashville, USA, September 2012.
[12] E. Kaplan and C. Hegarty, Understanding GPS: Principles and Applications. Artech House, 2005, 718 pp., ISBN: 978-1-58053-895-4.
[13]“Satellite Positioning Service of the German State Surveying Agencies—SAPOS®.” ( ), [Online]. Available: https://www.bezreg-koeln.nrw.de/brk_internet/geobasis/raumbezug/sapos/index.html (visited on 11/29/2021).
US-A-2002/0169578
WO-A-02/051028
US-A-2017/0102445
WO-A-98/032239

1. A method of reducing the effects of interference suppression on the measurement of the carrier phases of satellite navigation signals at the location of their reception, in which the method comprises:
a one- or multi-dimensional antenna array with a plurality of receiving antennas is provided,
satellite navigation signals received by the receiving antennas are processed in a signal processing unit,
an eigenbeamformer is applied to one or each of the received satellite navigation signals and parameters describing the same are calculated,
the parameters of the eigenbeamformer of the one satellite navigation signal or of each satellite navigation signal are measured or determined at times when no interference suppression is to be performed,
the received satellite navigation signals are subjected to interference suppression in the signal processing unit by means of a spatial filter, i.e. by means of spatial filtering, such as a power inversion (PI) filter or a projection filter, after which the carrier phases of the satellite navigation signals are distorted, and
after the interference suppression by means of the signal processing unit, the carrier phase of at least one or each of the satellite navigation signals is changed by calculating parameters from the current eigenbeamformer associated with the respective satellite navigation signal and the preceding eigenbeamformers associated with the respective satellite navigation signal, so that the distortions of the carrier phases resulting from the interference suppression are corrected.

2. The method according to claim 1, characterized in that the respective interference suppression is defined by a set of signal processing parameters for application to the satellite navigation signals to be suppressed, this set of parameters changing when interference affecting the satellite navigation signals, which interference arises from interference signals in the vicinity of the receiver or due to infrastructure in the vicinity of the receiver, changes, and that, when the interference changes,
the parameters of a new eigenbeamformer are calculated for the at least one satellite navigation signal or for each satellite navigation signal, so that the previously calculated carrier phase of the at least one satellite navigation signal or of each satellite navigation signal results when the respective new eigenbeamformer is applied, and
to compensate for the change in the carrier phase of the at least one satellite navigation signal or each satellite navigation signal calculated by the new eigenbeamformer resulting from the changed interference suppression parameter set, the parameters of the relevant new eigenbeamformer are further changed to rotate the calculated carrier phase.

3. The method of claim 1, characterized in that, at times when no interference suppression is to be performed, the parameters of the at least one eigenbeamformer define complex-valued beamforming weights with which the respective signals output by the receiving antennas per satellite navigation signal are weighted, in that either one of the receiving antennas is selected as the reference position, the weight for this receiving antenna being selected to be positive, real-valued (e.g. 1), or a position within the antenna array which does not coincide with one of the receiving antennas is selected, and in that the complex-valued weights for the receiving antennas of the antenna array are selected such that the carrier phase of a sum signal resulting per satellite navigation signal after weighting is equal to the carrier phase of the satellite navigation signal assigned to the eigenbeamformer, which arrives at the receiving antenna selected as the reference position of the antenna array or which would reach an antenna at the reference position of the antenna array not coinciding with a receiving antenna, the resulting sum signal being calculated as the sum of the complex-valued weighted, interference-suppressed receiving antenna signals, which in turn result from a complex-valued linear combination of the individual digitized receiving antenna signals and which are calculated from the receiving antenna signals by applying the interference suppression.

4. The method of claim 1, characterized in that the beamforming weights of the at least one eigenbeamformer are initialized with undisturbed satellite navigation signals by passing the satellite navigation signal at the reference position unchanged, whereby no direction-dependent carrier phase error arises in relation to this reference position as a result of the beamforming, the eigenbeamformer to be calculated being adapted, during a subsequent interference suppression, based on the previous eigenbeamformer with the aim that the phase of a resulting sum signal is still equal to the carrier phase of the satellite navigation signal at the reference position, the resulting sum signal being calculated as the sum of the complex-valued, interference-suppressed receiving antenna signals, which in turn result from a complex-valued linear combination of the individual digitized receiving antenna signals and which are calculated from the receiving antenna signals by applying the interference suppression.

5. A method for determining a distance of a receiver for satellite navigation signals from a satellite, in which the method comprises:
the method in accordance with claim 1 is performed; and
a pseudo-distance of the receiver to the satellite is calculated using the calculated carrier phase of the satellite navigation signal.

6. A method for determining a position of a receiver for satellite navigation signals, in which the method comprises:
the method in accordance with claim 5 is executed; and
the position of the receiver is determined using the distances between the receiver and several satellites.
